(19) United States
(12) Patent Application Publication
(10) Pub. No.: US 2008/0086356 A1
(43) Pub. Date: Apr. 10, 2008

(54) Determining advertisements using user interest information and map-based location information

(76) Inventors: Steve Glassman, Palo Alto, CA (US); Joshy Joseph, Los Altos Hills, CA (US); Bill Kilday, Menlo Park, CA (US); Sridhar Ramaswamy, Cupertino, CA (US); Giao Nguyen, Sacramento, CA (US); Dominic Preuss, New York, NY (US)

Correspondence Address: STRAUB & POKOTYLO, 620 TINTON AVENUE, BLDG. B, 2ND FLOOR, TINTON FALLS, NJ, 07724, US

(21) Appl. No.: 11/298,293

(22) Filed: Dec. 9, 2005

(51) Int. Cl. G06Q 30/00; G06F 17/40; G06F 19/00

(52) U.S. Cl. 705/10

(57) ABSTRACT

In response to a query for information in a geographic region or at a location, ranked ads may be plotted on, or in association with, a map (e.g., as a list beside the map), satellite photo, or any other form of visual representation of geographic information (referred to generally as “maps”). Sponsored ads might be shown in a dedicated place and/or might be elevated above other non-sponsored search results (e.g., Yellow Page listings). The number of ads shown in the list and/or plotted on the map could vary as a function of the resolution of the map or geographic image. The ads could be ranked or scored, and attributes or features of various ads may be a function of such a score or ranking. The plots on the map might be selectable to provide a pop-up with further information and possibly sponsored information (such as images, further ads, etc).

### § 1. BACKGROUND OF THE INVENTION

§ 1.1 Field of the Invention

The present invention concerns advertising. In particular, the present invention concerns determining advertisements (“ads”) using map-based location information.

§ 1.2 Related Art

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif. (referred to as “Google”), delivers ads targeted to keywords from search queries. Similarly, content targeted ad delivery systems have been proposed. For example, U.S. patent application Ser. Nos. 10/314,427 (incorporated herein by reference and referred to as “the '427 application”), titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and 10/375,900 (incorporated by reference and referred to as “the '900 application”), titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense advertising system by Google for example, have been used to serve ads on Web pages.

As can be appreciated from the foregoing, serving ads relevant to concepts of text in a text document and serving ads relevant to keywords in a search query are useful because such ads presumably concern a current user interest. Consequently, such online advertising has become increasingly popular. Moreover, advertising using other targeting techniques, and even untargeted online advertising, has become increasingly popular.

In addition to determining ads relevant to concepts of text in a text document, and determining ads relevant to keywords in a search query, U.S. patent application Ser. No. 10/654,265 (referred to as “the '265 application” and incorporated herein by reference), titled “DETERMINING AND/OR USING LOCATION INFORMATION IN AN AD SYSTEM”, filed on Sep. 3, 2003 and listing Leslie Yeh, Sridhar Ramaswamy, and Zhe Qian, discloses various techniques for determining ads relevant to an end user's location. However, these techniques can be improved.

In view of the foregoing, there is a need to improve the usefulness, and consequently the performance, of advertisements. In particular, there is a need to allow businesses to better target their ads to a responsive audience. For example, it would be useful to determine ads relevant to locations of interest that may differ from an end user's location.

### § 2. SUMMARY OF THE INVENTION

At least some embodiments consistent with the present invention allow businesses to better target their ads to a responsive audience. Such embodiments may do so by determining and using location information, such as a bounding area defined by a map, as well as information indicating a user interest (e.g., keywords from a search query, a category, a concept, a topic, document content, etc.), to determine ads. A set of such ads, referred to as “eligible ads” or “candidate ads”, may be narrowed in an arbitration process, such as an auction, to generate a set of ads to be rendered in association with the map.

In at least some embodiments consistent with the present invention, the ads may be rendered in a window including the map. For example, the ads may be displayed in an area adjacent to a map.

In at least some embodiments consistent with the present invention, the map may include graphical elements (e.g., push pin or marker icons), associated with the ads, denoting the location of the advertiser on the map. In at least some embodiments consistent with the present invention, upon selection of (e.g., due to a mouse click or cursor hover) the ad and/or the graphical element, expanded information may be rendered in association with the ad and/or the graphical element, or in place of the ad and/or graphical element.

The present invention may also use location information when determining a relevancy score of an ad.

At least some embodiments consistent with the present invention may provide tools, such as user interfaces, to allow an advertiser to enter and/or modify location information, such as location information used for targeting and location-dependent price information (e.g., bids).

### § 3. BRIEF DESCRIPTION OF THE DRAWINGS

FIG. 1 is a high-level diagram showing parties or entities that can interact with an advertising system.

FIG. 2 is a diagram illustrating an environment in which, or with which, embodiments consistent with the present invention may operate.

FIG. 3 is a bubble diagram illustrating various operations that may be performed, and various information that may be used and/or generated, by embodiments consistent with the present invention.

FIG. 4 illustrates exemplary request information that is consistent with the present invention.

FIG. 5 illustrates exemplary ad information that is consistent with the present invention.

FIG. 6 is a flow diagram of an exemplary method for performing an ad selection operation in a manner consistent with the present invention.

FIG. 7 is a flow diagram of an exemplary method for performing a scoring operation in a manner consistent with the present invention.

FIG. 8 is a flow diagram of an exemplary method of performing user behavior feedback operations in a manner consistent with the present invention.

FIG. 9 is a flow diagram of an exemplary method for performing ad information entry and/or management operations in a manner consistent with the present invention.

FIG. 10 is a block diagram of an exemplary apparatus that may perform various operations and store various information in a manner consistent with the present invention.

FIG. 11 is an exemplary display screen which includes a map that is consistent with the present invention.

FIGS. 12-14B depict exemplary display screens, each including a map, advertisements, and marker icons, and each being consistent with the present invention.

FIG. 15 is an exemplary display screen which includes a map with marker icons and which is consistent with the present invention.

FIG. 16 is an exemplary display screen which includes search results and advertisements, some of which advertisements include a selectable element to allow a user to see advertiser information on a map.

FIGS. 17-19 depict exemplary display screens, each including a map, advertisements, and marker icons, and each being consistent with the present invention.

### § 4. DETAILED DESCRIPTION

The present invention may involve novel methods, apparatus, message formats, and/or data structures for improving the selection of ads using map-based location information. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Also, as used herein, the article “a” is intended to include one or more items. Where only one item is intended, the term “one” or similar language is used. In the following, “information” may refer to the actual information, or a pointer to, identifier of, or location of such information. No element, act or instruction used in the description should be construed as critical or essential to the present invention unless explicitly described as such. Thus, the present invention is not intended to be limited to the embodiments shown and the inventors regard their invention to include any patentable subject matter described.

In the following definitions of terms that may be used in the specification are provided in § 4.1. Then, environments in which, or with which, the present invention may operate are described in § 4.2. Exemplary embodiments of the present invention are described in § 4.3. Finally, some conclusions regarding the present invention are set forth in § 4.4.

§ 4.1 Definitions

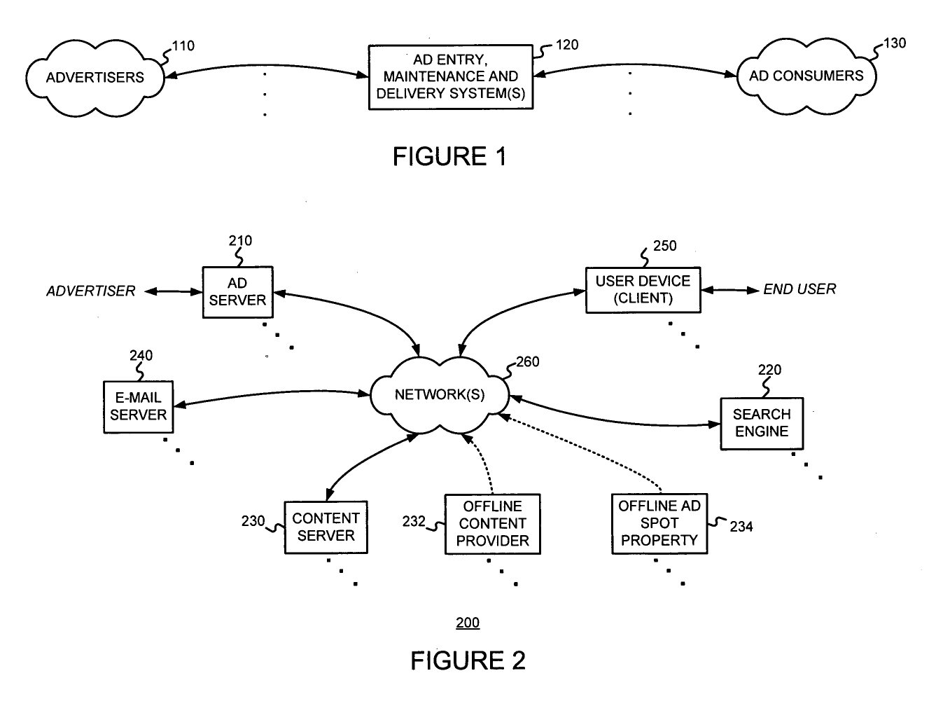

Online ads, such as those used in the exemplary systems described below with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served (e.g., locations bound by a map on which the ad was served), a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location or area.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate” or “CTR”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page,.and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, selecting a predetermined number of tabs of a multi-tabbed ad, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet. A document may include geographic information, such as a map.

A “Web document” includes any document published on the Web. Examples of Web documents include, for example, a Website or a Web page.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

A “map” is to be broadly interpreted to include (manually or automatically) illustrated maps, aerial images, satellite images, other visual representations of the earth or other physical objects, etc. Maps typically represent an area too large to be seen by a human viewer at a given ground-level location. A map may be a two-dimensional or three-dimensional representation. A map may include images or representations of geographical features, man-made features (e.g., buildings), or both.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

§ 4.2 Exemplary Advertising Environments in Which, or with Which, Embodiments Consistent with the Present Invention May Operate

FIG. 1 is a diagram of an advertising environment in which embodiments consistent with the present invention may operate. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geolocation-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or service). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 230 may permit user devices 250 to access documents and other information. Examples of a content servers 230 include a map server, such as Google Maps and Google Earth. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities. Similarly, information-relevant ads may be served in association with information (e.g., map information) provided by the content server. Thus, content servers 230 may serve predetermined and stored content such as articles, as well as dynamically generated information such as a map centered at a particular location and with a particular scope.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, maps, etc.), and retrieves the requested document or information in response to, or otherwise services, the request. The content server 230 may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information (e.g., locations of an area bounding map information), document information, etc. Note that a map server may provide maps to another content server such that the map can be integrated into a document served by the other content server.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

The offline content provider 232 may provide information about ad spots in an upcoming publication, and perhaps the publication (e.g., the content or topics or concepts of the content), to the ad server 210. In response, the ad server 210 may provide a set of ads relevant the content of the publication for at least some of the ad spots. Examples of offline content providers 232 include, for example, magazine publishers, newspaper publishers, book publishers, offline music publishers, offline video game publishers, a theatrical production, a concert, a sports event, etc.

Owners of the offline ad spot properties 234 may provide information about ad spots in their offline property (e.g., a stadium scoreboard banner ad for an NBA game in San Antonio, Tex.). In response, the ad sever may provide a set of ads relevant to the property for at least some of the ad spots. Examples of offline properties 234 include, for example, a billboard, a stadium score board, and outfield wall, the side of truck trailer, etc.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, selection or not, impression time, impression date, size, conversion or not, etc.) back to the ad server 120/210. Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

§ 4.3 Exemplary Embodiments

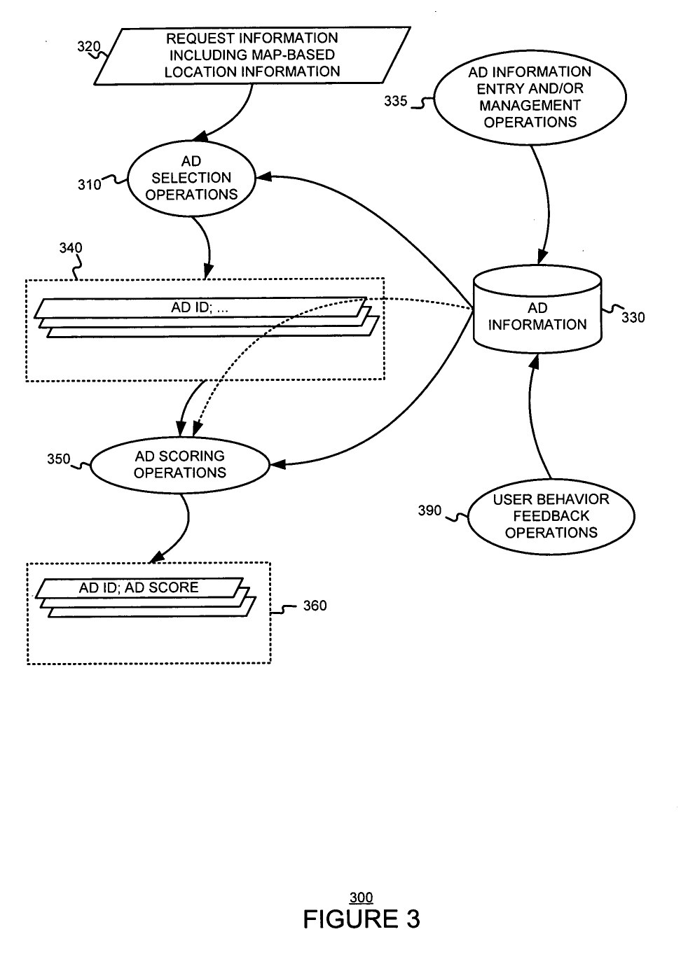

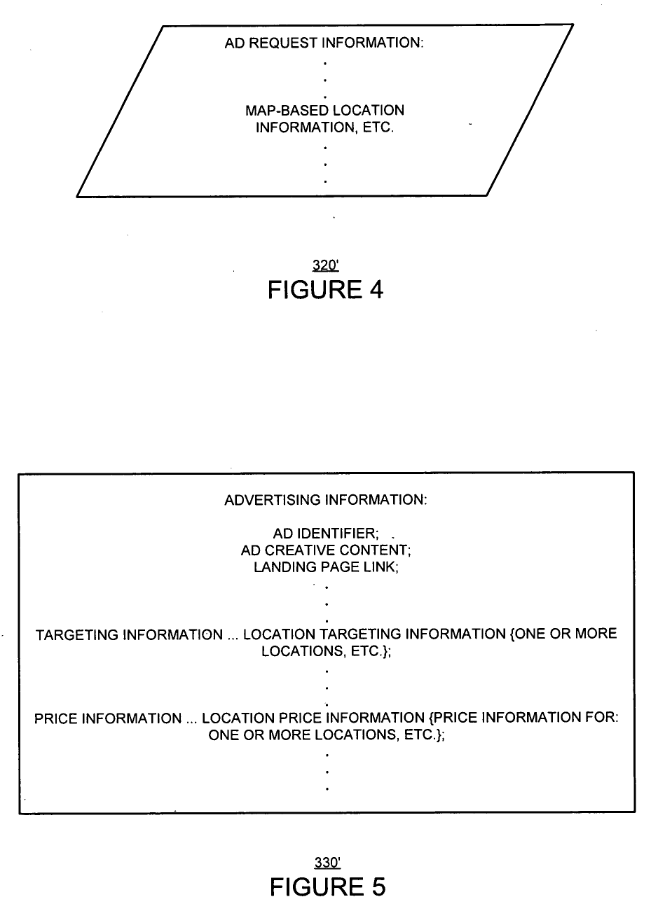

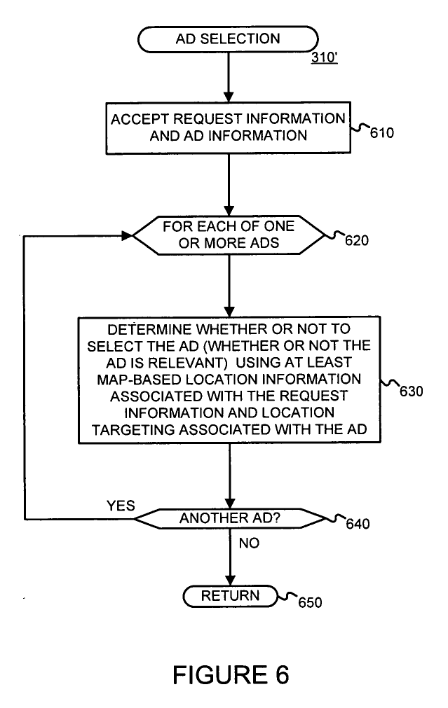

FIG. 3 is a bubble diagram illustrating various operations that may be performed by an ad server consistent with the present invention, and various information that may be used and/or generated by such operations. Ad selection operations 310 may be used to generate a set of one or more ads 340 using ad information 330 and request information 320. In an exemplary embodiment consistent with the present invention, the set of ads 340 may include ads relevant to the request information 320. For example, if the request information 320 is associated with a search query, the ads 340 may be relevant to terms of the search query. Alternatively, if the request information 320 is associated with a document to be served, the ads 340 may be relevant to content of the document. In any event, the request information 320 includes map-based location information. For example, the request information 320 may include bounds of a geographic area that is shown in a map. Exemplary data structures that may be used to store request information 320 and ad information 330 are described in § 4.3.1 below with reference to FIGS. 4 and 5, respectively. Exemplary methods that may be used to perform the ad selection operation 310 are described in § 4.3.2 below with reference to FIG. 6.

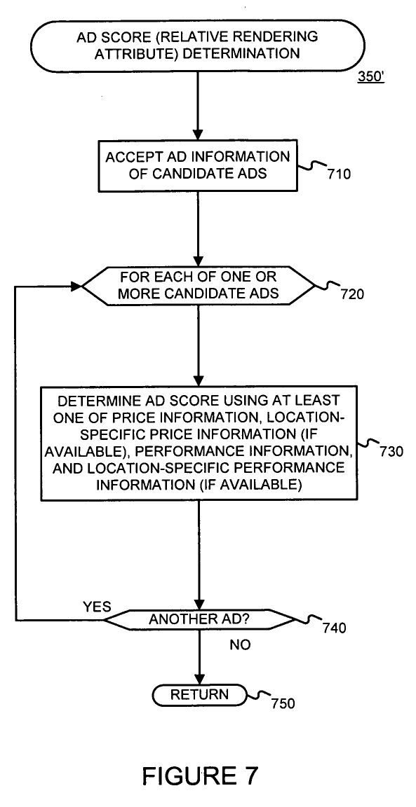

Still referring to FIG. 3, ad scoring operations 350 may be used to generate a set 360 of one or more ads and associated scores (and/or rankings) using the first set 340 of ads and ad information 330. The scoring operation 350 may consider map-based location information, such as location performance information, and/or location price information for example, of the ads. Alternatively, or in addition, the scoring operation 350 may consider more generic performance information and price information. Exemplary methods that may be used to perform the scoring operation 350 are described in § 4.3.2 below with reference to FIG. 7.

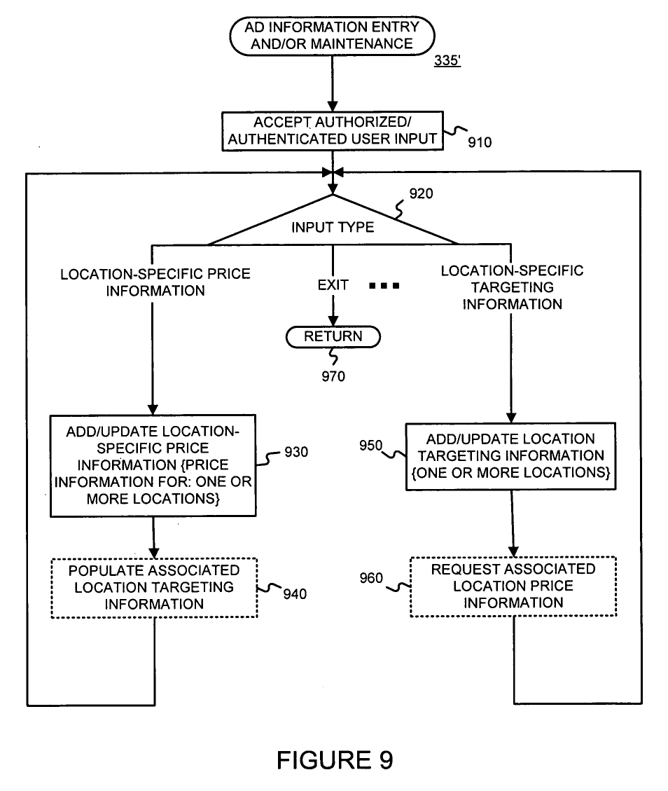

The ad information 330 may include map-based location performance information. Such information may be provided, and/or tracked by user behavior feedback operations 390. Exemplary methods that may be used to perform the user behavior feedback operations are described in § 4.3.2 below with reference to FIG. 9.

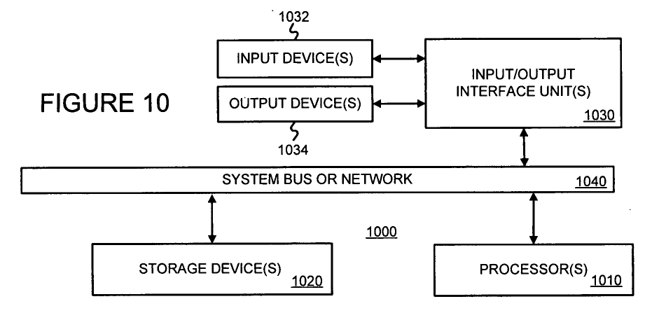

Finally, the ad information 330 may include map-based location targeting, and/or map-based location price information. This information may be entered and/or modified by advertisers, or their representatives via ad information entry and/or management operations 335. Exemplary methods that may be used to perform these operations 335 are described in § 4.3.3 below with reference to FIG. 10.

Embodiments consistent with the present invention need not provide, and/or use all of the operations and information described with reference to FIG. 3, and need not perform the operations in the order shown. Finally, the present invention may combine, or separate functionality described with respect to the various operations. For example, the selection and scoring operations 310 and 350 may be combined into a single operation.

§ 4.3.1 Exemplary Data Structures

FIG. 4 illustrates exemplary ad request information 320′ that is consistent with the present invention. The ad request information 320′ may include information such as that described in § 4.1.1 above. As shown, the ad request information may include map-based location information. Such information may be used to target the serving of ads. Such information may also be used in the scoring or ranking of ads.

The map-based location information may be encoded in various ways. For example, the map-based location information may be encoded as coordinates (e.g., latitude and longitude) in one or more locations (e.g., corners) of a map. If only one pair of coordinates is provided, a size (or scale) of the map should also be provided. Other ways of encoding map-based location information may be used.

FIG. 5 illustrates exemplary ad information 330′ that is consistent with the present invention. The ad information 330′ may include information such as that described in § 4.2 above. For example, the ad information 330′ may include a unique ad identifier, ad creative content (or a pointer to such creative content), and/or a landing page link, etc. Further, the exemplary ad information 330′ may include at least one of map-location targeting information and map-location price information. Map-location performance information (not shown) may be tracked and associated with the ad.

Map-location targeting information may include one or more geographic locations and/or areas that the advertiser to which the advertiser wants to target its ads. For example, the map location targeting information may be a specific location and a specified radius of service. For example, a theme park may have a larger radius of service than a limousine service, which may have a larger radius of service than a local pizzeria. Map-location price information may include price information for each of one or more areas. The map-location price information should correspond to the map-location targeting information. The map-location price information may be a function of a distance from a particular location. For example, techniques described in U.S. patent application Ser. No. 11/096,283 (incorporated herein by reference and referred to as “the '283 application”), filed on Mar. 31, 2005, titled “AUTOMATED OFFER MANAGEMENT USING AUDIENCE SEGMENT INFORMATION” and listing Ross Koningstein as the inventor may be used.

In one embodiment of the present invention, geolocation targeting information can be inferred from geolocation price information. For example, if an advertiser submits a maximum bid per impression of $1.50 a certain geographic point, it may be assumed that the advertiser wants to target its ads to end users viewing a map including that point. Similarly, if the advertiser submits a bid per impression of $0.00 for a given geographic area, it may be assumed that the advertiser wants to avoid serving its ads to end users viewing a map of the given geographic area.

§ 4.3.2 Exemplary Methods

FIG. 6 is a flow diagram of an exemplary method 310′ for performing ad selection operations 310 in a manner consistent with the present invention. Request information and ad information is accepted. (Block 610) The request information may include, among other things, map-based location information. The advertising information may include, among other things, map-location targeting information. As indicated by loop 620-640, an act is performed for each of one or more ads. More specifically, a relevancy measure of the ad is determined using at least map-based location information associated with the request information and map-location targeting information associated with the ad. (Block 630) After each of the one or more ads has been processed, the method 310′ is left. (Node 650)

The relevancy of the ad may be determined using keyword targeting information associated with the ad, ad relevance information associated with the ad, etc. In any event, the relevancy of the ad may be determined using, at least, map-based location information of the request and the ad. In at least some embodiments consistent with the present invention, the more specific the map-location information that matches (e.g., smaller geographic area), the more relevant, at least in terms of location, the ad is. Thus, for example, if an end user is viewing a map including San Diego, Calif., assuming all other relevancy factors are equal, an ad with map-targeting for San Diego, Calif. may be more relevant than an ad with map-targeting for California, which may be more relevant for an ad with map-targeting for the West Coast, which may be more relevant for an ad with map-targeting for the United States. That is, different location information may have different scope, and some location information may contain other location information. Generally, for purposes of determining ad relevancy, a match of more specific location information (e.g., a smaller area) may be weighted more heavily than a match of less specific location information (e.g., a larger area).

Naturally, map-location targeting may be just one of a number of relevancy factors. For example, ad relevancy may also consider (a) a comparison of ad relevancy information to the content of a document requested, (b) ad keyword targeting with respect to terms of a search query, (c) user demographic information, (d) user behavior information, (e) time/date/season targeting information, etc.

FIG. 7 is a flow diagram of an exemplary method 350′ for performing a scoring operation 350 in a manner consistent with the present invention. The score may be used to determine a relative presentation attribute (e.g., size, color, volume, enhanced elements, enhanced marker icon attributes, enhanced information bubble attributes, etc.) of the ad. Techniques described in U.S. patent application Ser. No. 10/610,350 (incorporated herein by reference and referred to as “the '350 application”), filed on Jun. 30, 2003, titled “USING ENHANCED AD FEATURES TO INCREASE COMPETITION IN ONLINE ADVERTISING” and listing Eric Veach as the inventor may be used to apply enhanced features. Ad information of candidate ads is accepted. (Block 710) As indicated by loop 720-740, an act is performed for each of one or more ads. More specifically, an ad score is determined using at least one of price information, map-location price information (if available), performance information, and map-location performance information (if available). (Block 730) Once all of the candidate ads are processed, the method 350′ is left. (Node 750)

There are a number of ways to determine an ad score consistent with block 730. A few exemplary ways are described below. If an ad system wants to maximize revenue, it may determine a score by multiplying a price per performance value by the performance of the ad. For example, it may determine cost per click*click-through rate, or cost per conversion*conversion rate. Prices may be discounted or adjusted. The present invention can advantageously use map-location information, if available, to improve a revenue estimate. For example, suppose the end user to whom the ad will be directed is viewing a map including San Diego. Suppose further that the following otherwise equally relevant ads have the associated information shown:

| | |
|---|---|
| Ad A: | max cost per click = $0.25; |
| | max cost per click = $1.00 in San Diego; |
| | CTR = 0.02 in United States; |
| | CTR = 0.04 in California; |
| | CTR = 0.20 in San Diego. |
| Ad B: | max cost per click = $0.50; |
| | max cost per click = $2.00 in Florida; |
| | CTR = 0.07 in United States; |
| | CTR = 0.02 in California; |
| | CTR = 0.02 in San Diego. |

Without map-location scoring, a simple product score for ad A would be 0.0050 (=0.25*0.02), while that for ad B would be 0.0350 (=0.50*0.07). With map-location scoring, a simple product score for ad A would be 0.20 (=1.00*0.20), while that for ad B would be 0.01 (=0.50*0.02). Thus, without map-location information, ad B would score higher than ad A, but with map-location information ad A would score higher than ad B. For example, ad A may be for a restaurant in San Diego, while ad B might be for restaurant chain with a large presence in Florida. By using map-location information, the present invention may advantageously serve ad A with some preference over ad B since it may normally be more useful for an end user interested in a map including San Diego.

Embodiments consistent with the present invention may also use proximity (e.g., to a end user entered address or position, to a center of a map, etc.) when determining a score. Generally, if all other factors are equal, an ad with a location closer to a center of a map or an end user specified location will have a higher score than an ad with a location farther to a center of a map or an end user specified location. The affect of such a distance on ad score may be applied continuously, or in discreet amounts. Yet other factors may be considered when scoring ads. Such factors may include using a local availability of an item sought by the end user, using advertiser attributes (e.g. a location of the advertiser's closest retail outlet), etc.

In at least some embodiments consistent with the present invention, for purposes of ad scoring, the most specific location price and/or performance information that matches will be used. In various embodiments consistent with the present invention, ads can be targeted using (A) a targeted location “contained in” map, (B) map “contained in” targeted location, and/or (C) intersection of at least a portion of the map and at least a portion of the targeted location.

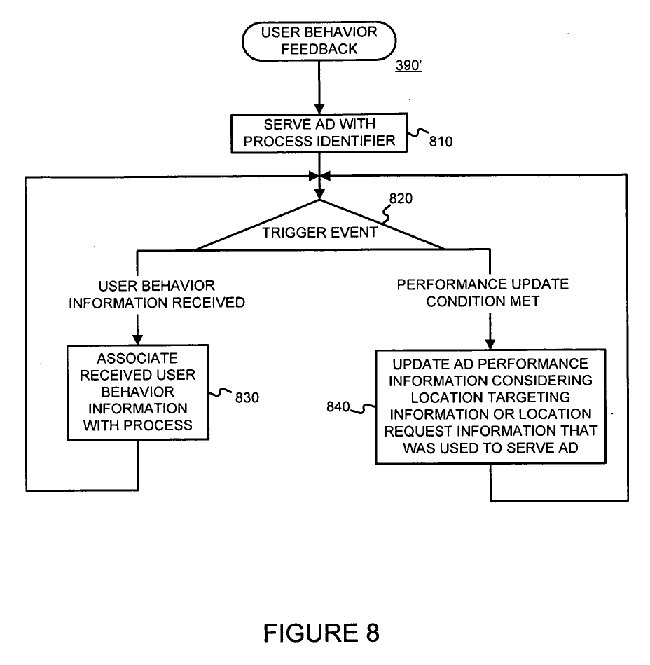

FIG. 8 is a flow diagram of an exemplary method 390′ for performing user behavior feedback operation 390 in a manner consistent with the present invention. Recall from scoring operation 350 that map-location specific performance information may be used in determining a score for an ad. The method 390′ of FIG. 8 is one way to track such information. Each time an ad is served, this event may be identified by a unique process identifier (e.g., ad server IP address, a date and a time of day). The process identifier may be associated with any map-location targeting information used when serving the ad, or map-location information of the relevant request. The ad may be served with its process identifier. (Block 810) As indicated by event block 820, different branches of the method 390′ may be performed in response to different events. For example, if user behavior information is received, the received user behavior information is associated with the process identifier (and therefore the map-location information, if any, used when originally serving the ad) (Block 830) before the method 390′ branches back to event block 820. If a condition for updating performance information is met (e.g., the receipt of performance information, the receipt of a certain amount of performance information, a time expiration since the last update, an absolute time/date, etc), the ad performance information is updated considering map-location targeting information, or map-location request information associated with the ad serving process (Block 840), before the method 390′ branches back to event block 820.

Thus, the method 390′ can be used to track ad performance information accounting for map-location information that may have been used when serving the ad. Various alternative ways of associating map-location information with performance information are possible. Although not shown, the size of the area represented by the map may be used to track the performance of an ad. For example, an ad with a coupon for a coffee shop may perform much better with a map representing a few square blocks than with a map representing a city.

FIG. 9 is a flow diagram of an exemplary method 335′ of performing ad information entry and/or management operations in a manner consistent with the present invention. Recall from FIG. 5 that ad information 330′ may include one or more of map-location targeting information and map-location price information. The method 330′ accepts authorized and/or authenticated advertising user input. (Block 910) As indicated by event block 920, various branches of the method 335′ may be performed in response to various input types. If the advertiser inputs map-location price information, map-location price information is added or updated. (Block 930) Associated map-location targeting information may also be populated or revised in accordance with the price information. (Block 940) For example, if a user enters a maximum price per click of $0.80 for a one-mile radius from 123 Main Street, Anytown, Calif., and if the ad does not include map-location targeting for that area, such information may be added. If the user later changes this maximum price per click for this area to $0.00, the map-location targeting for this area may be turned off or removed. Referring back to block 920, if the user inputs map-location targeting information, the map-location targeting information is added or updated. (Block 950) Associated map-location price information may be requested (Block 960) but need not be provided.

In one embodiment of the present invention, if an advertiser inputs geolocation targeting information, it may be advisable to have them remove location modifiers used in keyword targeting.

In one embodiment of the present invention, advertisers may be limited in the number and/or combination of types of map-location information entered.

Other features of the advertiser user interface may be provided to make entering and/or managing advertising information more convenient. For example, if any advertiser has an existing campaign, but wants to add a map-location targeted campaign, bulk importing support may be provided so that the advertiser does not need to re-enter common advertising information. Help features may be used to suggest additional map-location information (more of the same type, more specific, more general, etc.) in response to entered map-location information.

§ 4.3.3 Exemplary Apparatus

FIG. 10 is high-level block diagram of a machine 1000 that may perform one or more of the operations discussed above. The machine 1000 basically includes one or more processors 1010, one or more input/output interface units 1030, one or more storage devices 1020, and one or more system buses and/or networks 1040 for facilitating the communication of information among the coupled elements. One or more input devices 1032 and one or more output devices 1034 may be coupled with the one or more input/output interfaces 1030.

The one or more processors 1010 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 1020 and/or may be received from an external source via one or more input interface units 1030.

In one embodiment, the machine 1000 may be one or more conventional personal computers. In this case, the processing units 1010 may be one or more microprocessors. The bus 1040 may include a system bus. The storage devices 1020 may include system memory, such as read only memory (ROM) and/or random access memory (RAM). The storage devices 1020 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1032, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1010 through an appropriate interface 1030 coupled to the system bus 1040. The output devices 1034 may include a monitor or other type of display device, which may also be connected to the system bus 1040 via an appropriate interface. In addition to (or instead of) the monitor, the personal computer may include other (peripheral) output devices (not shown), such as speakers and printers for example.

Referring back to FIG. 2, one or more machines 1000 may be used as end user client devices 250, content servers 230, search engines 220, email servers 240, and/or ad servers 210.

§ 4.3.4 Exemplary Ad-Map Displays

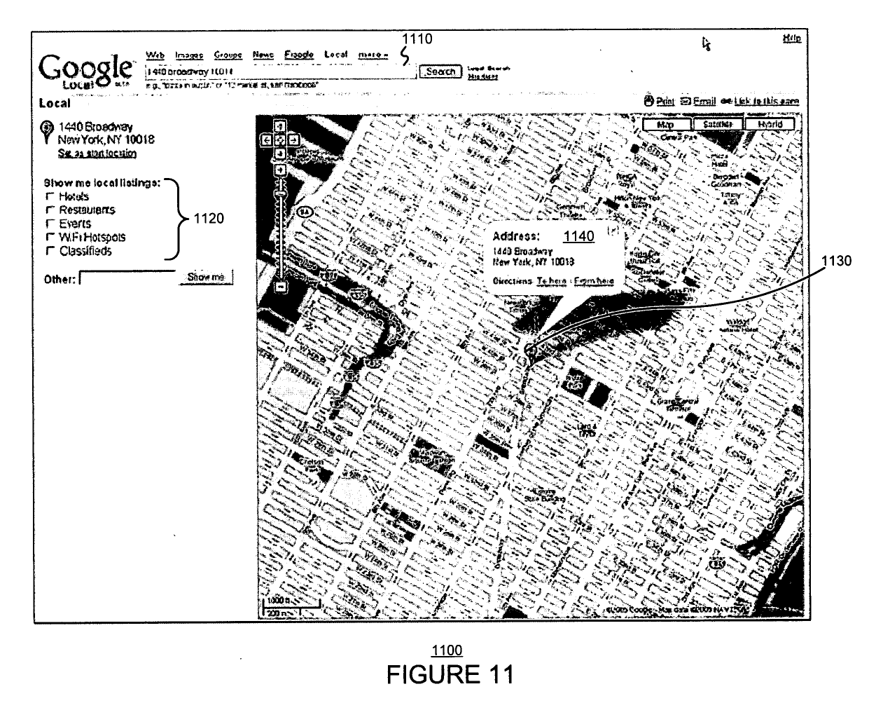

FIG. 11 is an exemplary display 1100 of a map generated in response to a query entered in box 1110. As shown, the map includes a marker icon 1130 corresponding to the address searched on, as well as an informational bubble element 1140 with the address and links to directions to and from the location. In this example, ads are not shown by default, but only if the user does something to trigger the serving of ads. (This may be because no other information other than the address is available and many ads or listings within the map might not be relevant or useful to the end user.) For example, the user may elect to search local listings for one or more of hotels, restaurants, events, WiFi hotspots, and classifieds by selected appropriate items 1120, and may search other items by via text entry box.

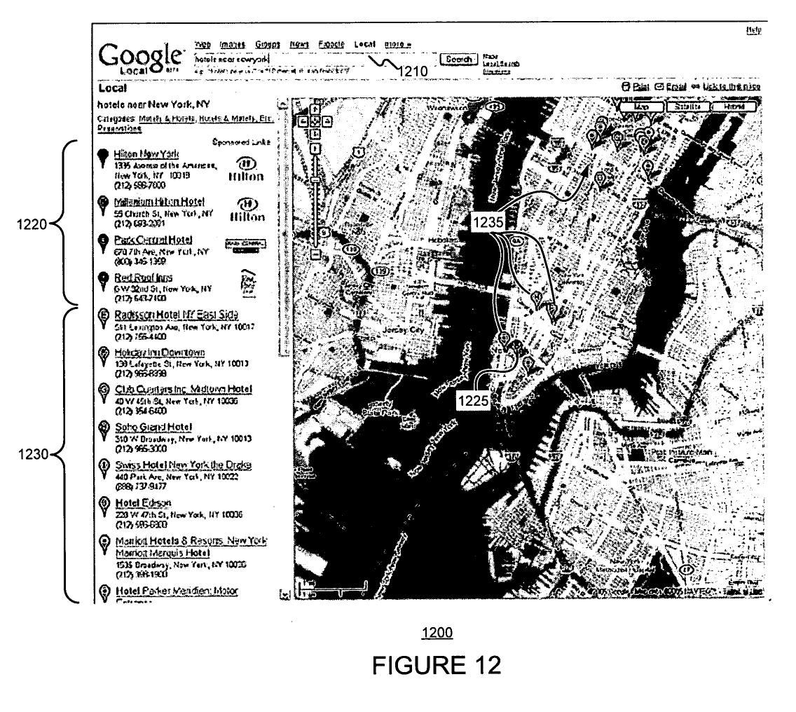

Suppose that the user elected to search local listings for hotels. FIG. 12 is an exemplary display 1200 of a map generated based on information entered in text box 1210 (and/or a user selection to search for hotel listings in the display 1100 of FIG. 11 (where map is resized)). In this example, it may be assumed that the user is interested in commercial listings due to their entry of the term “hotel” (or their selection of hotels). The left column adjacent to the map includes a first set of listings (e.g., paid or premium listings) 1220, and a second set of listings (e.g., unpaid or standard listings, such as listings uploaded from a directory (e.g., the Yellow Pages)) 1230. As shown, each of the first set of listings 1220 may include a custom logo and/or other branding elements. Although not shown, each of the first set of listings 1220 may also be associated with enhanced (e.g., larger, more visible, animated, larger font, etc.) marker icons on the map. In this example, all of the listings of the first type 1220, and at least some of the listings of the second type 1230, include marker icons 1235 on the map at a location associated with the listing. Note that it may be desirable to make the marker icons for the paid listings 1220 less noticeable than those for the unpaid listings 1230.

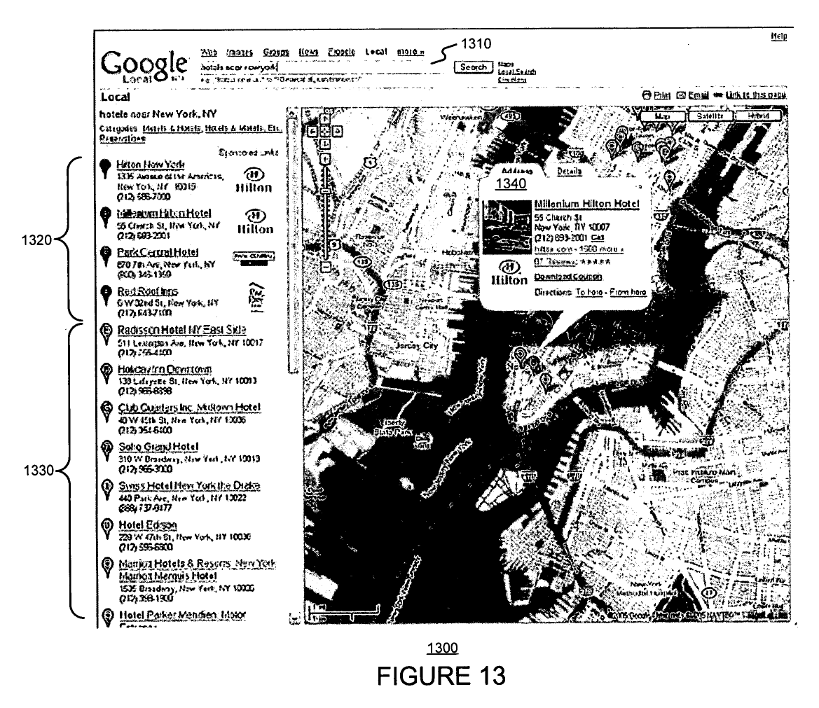

Still referring to FIG. 12, suppose that a user selects (e.g., by hovering over and/or clicking on the second listing and/or the associated marker icon 1225) the second listing, an enhanced information bubble may be generated. As shown in the display 1300 of FIG. 13, an exemplary enhanced information bubble 1340 includes a small image, a branding element, and additional information (e.g., a link to an ad landing page, reviews, coupons, etc.). Notice also that the exemplary enhanced information bubble 1340 may include multiple tabs (e.g., Address and Details). Other enhanced features (not shown) may include click-to-call functionality.

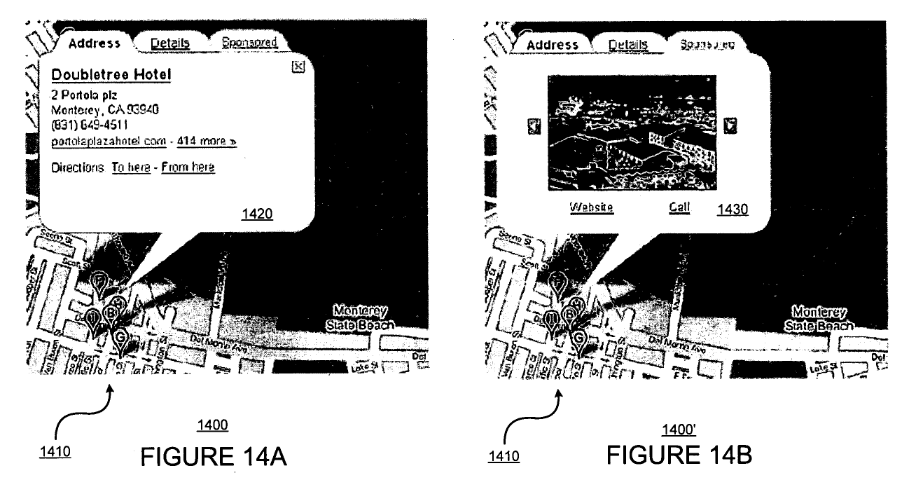

FIGS. 14A and 14B illustrate different tabs of an exemplary multi-tab ad component that is consistent with the present invention. FIG. 14A includes a map screen 1400 which includes a number of marker icons 1410, one of which is selected. The in response to the marker icon selection, a multi-tab information bubble is rendered. A first tab 1420 includes address information. As shown in the map screen 1400′ of FIG. 14B a second tab 1430 includes an image (which may be one of a number of images of a “slide show”), a link to an ad landing page or Website, and click-to-call text.

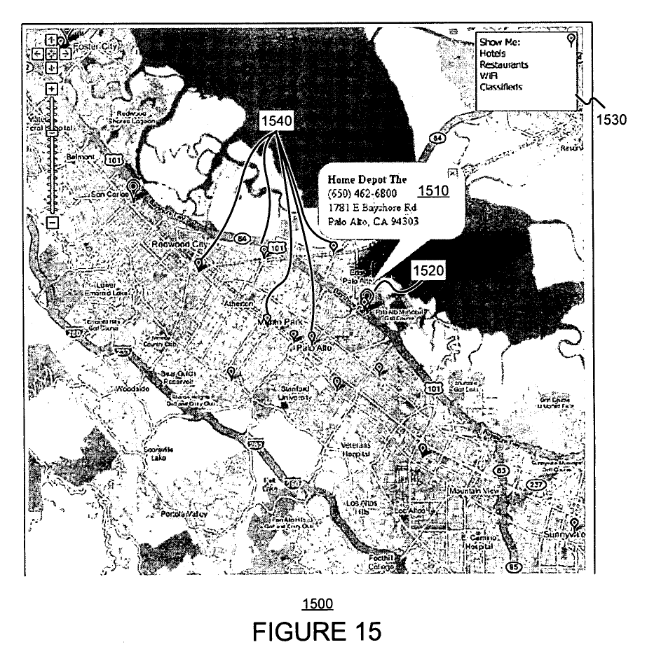

FIG. 15 illustrates a screen 1500 including an information bubble ad 1510 and an associated marker icon 1520. Further, suppose that a user wanted to have WiFi hot spots shown on the map. In this example, they selected WiFi in a Show Me menu 1530. As a result of that selection, various marker icons 1540 corresponding to various WiFi hot spots are shown on the map 1500. Note that the elements in the “show me” box 1530 may be related information (e.g., related searches). Such user-selectable related information is useful in instances where there is insufficient information to determine ads to a desired degree of relevance or usefulness. Techniques such as those described in: U.S. patent application Ser. No. 10/748,870 (incorporated herein by reference and referred to as “the '870 application”), filed on Dec. 29, 2003, titled “IDENTIFYING RELATED INFORMATION GIVEN CONTENT AND/OR PRESENTING RELATED INFORMATION IN ASSOCIATION WITH CONTENT-RELATED ADVERTISEMENTS” and listing Jeffrey A. Dean, Krishna Bharat and Paul Buchheit as inventors; U.S. patent application Ser. No. 10/814,101 (incorporated herein by reference and referred to as “the '101 application”), filed on Mar. 31, 2004, titled “PROVIDING LINKS TO RELATED ADVERTISEMENTS” and listing Brian Axe, Jerry Felker and Ross Koningstein as inventors; and U.S. Provisional Application Ser. No. 60/737,267 (incorporated herein by reference and referred to as “the '267 provisional”) filed on Nov. 16, 2005, titled “RENDERING CONTEXTUAL RELATED CONTENT WITH A DOCUMENT, SUCH AS ON A WEB PAGE FOR EXAMPLE” and listing Jeffery Eddings, Jerry Felker, Shuman Ghosemajumder, Nathan Lucash and Hunter Walk as inventors, may be used to determine related information. For example, obtaining related information may be useful when a third party uses API to get a map from a map server (though information can be derived from a third party Webpage or Website).

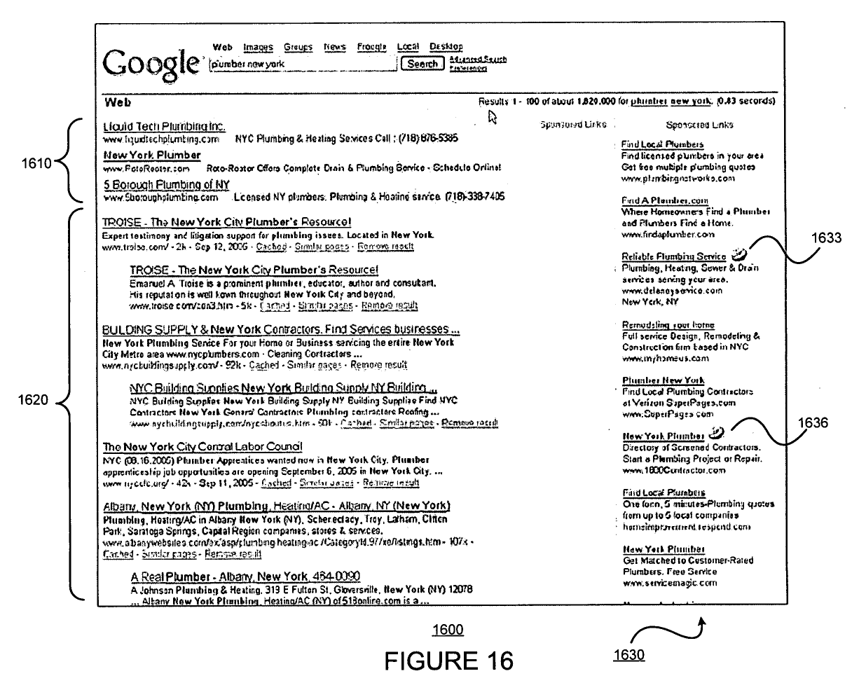

FIG. 16 illustrates a search results page 1600 generated in response to the query “plumber new york”. The search results page 1600 includes premium ads listings 1610, search results 1620, and keyword-relevant ads 1630. Notice that some of the ads 1630 may include a compass icon (or some other icon) 1633, 1636 that would link to a listing of locations on a maps server, such as Google maps for example. Additional ads or listings may be generated for the map using map-based location information and search query information.

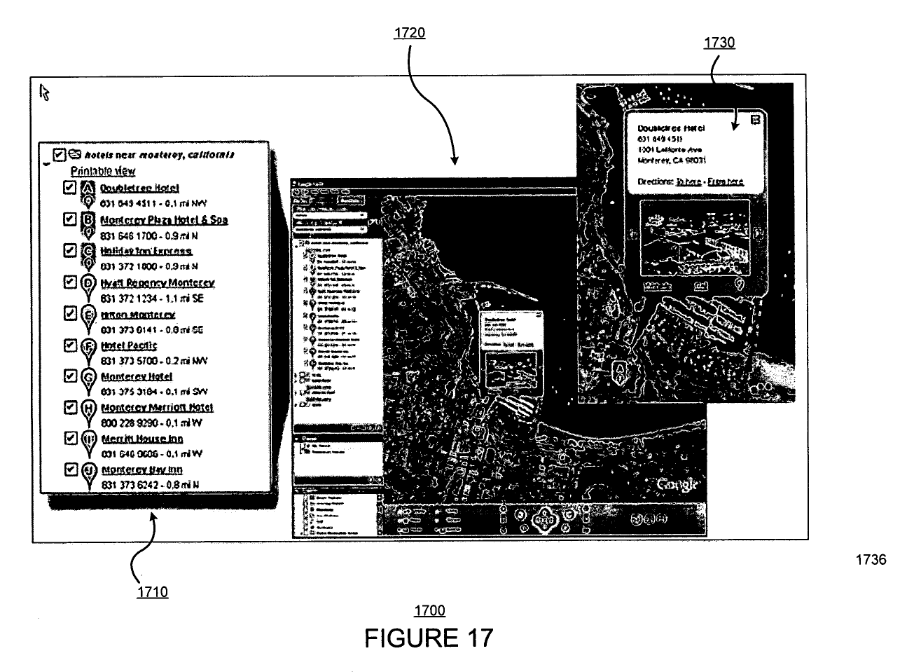

As shown in FIG. 17, maps may include aerial (e.g., satellite) images. Image 1720 includes listings and marker icons, one with an information bubble. Blow up 1710 includes listings of hotels near Monterey, Calif. Blow up 1730 illustrates the information bubble which includes an address, an image (which may be a part of a slide-show), a text link to an ad landing page, and click-to-call text.

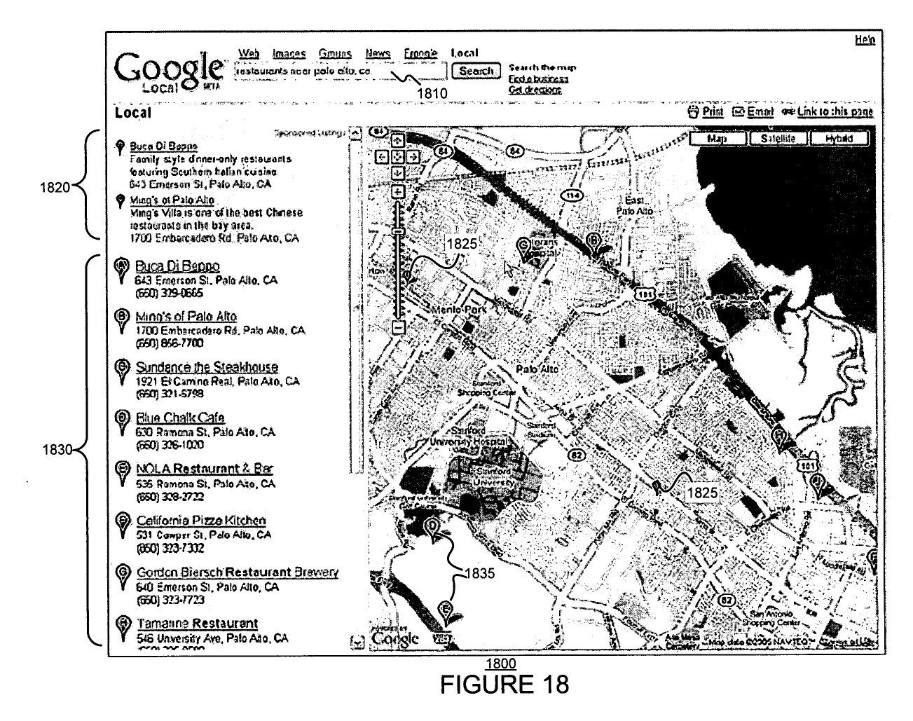

FIG. 18 includes a screen 1800, generated in response to the query in text box 1810. The screen 1800 includes a map and associated listings 1820 and 1830 adjacent to the map. The listings include associated marker icons on the map. The first set of listings 1820 includes paid advertiser listings. Notice that these listings include a multiple line marketing message. The second set of listings 1830 may include information from a directory. Marker icons 1835 are associated with the second listings 1830 using unique letters. Although the first set of listings 1820 might include telephone numbers, it may be preferable to not provide such numbers (unless calls can be associated with user-ad interactions) so that ad performance (e.g., in terms of user actions) can be tracked. Notice that in this particular exemplary embodiment, the marker icons for the first set of listings 1820 are less noticeable than those for the second set of listings 1830. Thus, commercial listings don't corrupt more neutral, and perhaps more useful, listings. Naturally, other embodiments may use similar marker icons for both listings, or better marker icons for the first set of listings 1820.

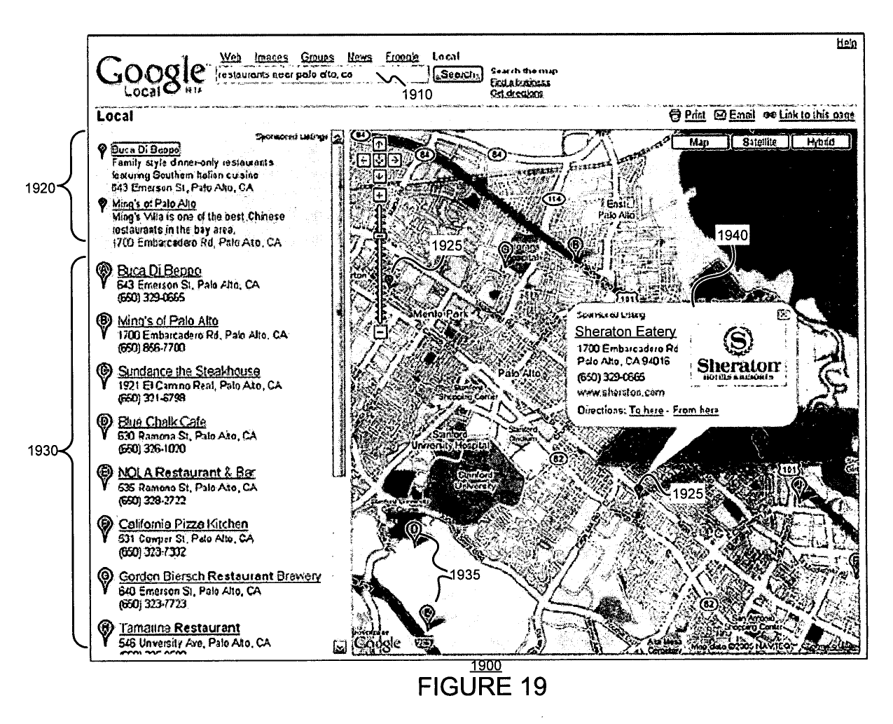

FIG. 19 includes a screen 1900, which is similar the screen 1800 of FIG. 18, but in which an information bubble 1940, associated with an enhanced listing, is displayed.

As can be appreciated from the foregoing, various types of ad creatives may be used in various embodiments consistent with the present invention. A few exemplary types of ad creatives are described below.

A first ad creative type may include one or more of:
an ad title (e.g., 25 Characters);
a second line of text (e.g., 35 Characters);
a third line of text (e.g., 35 Characters);
a logo (e.g., 75×50 pixels);
a photo of the advertiser's business or business location (e.g., 180×150 pixel); and
a telephone number
   The ad title may be set to a business title extracted from a directory listing. Similarly, the telephone number may be set to a value extracted from a directory listing.

A second ad creative type may include one or more of:
a logo (e.g., 50×50 pixels);
a photo of the advertiser's business or business location (e.g., 100×200 pixel);
one line of text (a tagline) for that location (e.g., no more than 35 characters); and
a business address and telephone number (which may be extracted from a directory listing).

Various information could be displayed on a primary tab of an information bubble. Alternatively, or in addition, a new “sponsored” tab that could be the default primary tab of the information bubble may be created.

In at least some embodiments consistent with the present invention, marker icon displayed on a map may include a small logo or other means for association with an advertiser to help differentiate the marker icon from others. For example, in such embodiments, if a user searches on “Pizza 10018”, some of the markers may show the Domino's logo. This would be useful to both the advertiser, as well as the end user.

In at least some embodiments consistent with the present invention the marker icons for paid listings could be made smaller with lower priority on the map (unless otherwise relevant) than directory listings. Naturally, it may be useful to make marker icons for paid listings larger, or more visible, or more informative. In still other embodiments, the attributes of a marker icon may be a function of an ad's score. In such embodiments, higher scoring ads could be associated with more visible, and/or more informative marker icons than lower scoring ads. Techniques described in the '350 application may be used.

§ 4.3.5 Alternatives and Refinements

§ 4.3.5.1 Types of Listings

Although many of the exemplary embodiments described above provide information about relevant businesses (e.g., hotels, restaurants, etc.) in a geographic area depicted on a map, other types of information may be provided. Examples of other types of information include, real estate search listings, event search listings, etc.

Embodiments consistent with the present invention may be used with other types of geographically-sensitive advertising such as cell phones, mesh WiFi, etc. For example, a user location may be determined, ads may be determined using at least the user location, and the ads and/or components thereof (e.g., marker icons) may be provided on a map to be rendered on the display of a mobile device, such as a mobile telephone. Embodiments consistent with the present invention could be used to plot ads on maps used in mobile applications such as GPS or other such devices used in cars, trains, planes, or handheld wireless devices. The ad information could be generated and sent to mobile applications in real-time or static versions of ad information could be stored along with maps used in mobile applications.

§ 4.3.5.2 Map Server—Ad Server Relationships and Syndication

Referring back to FIG. 2, in some embodiments consistent with the present invention, the ad server 210 may be the same entity as (or controlled by the same entity as) the map server 230. However, other embodiments consistent with the present invention may be used in syndication environments where mapping applications are provided to third parties that are not controlled by the ad server 210.

§ 4.3.5.3 Advertiser Front End Interface

Referring back to operations 335 of FIG. 3, different advertisers can provide information in different ways. For example, in at least some embodiments consistent with the present invention, a small advertiser might create a new account with ads for each of their store locations and enter the address of each location. As another example, in at least some embodiments consistent with the present invention, a GoogleBase user uploading a classified listing might be given the opportunity to advertise their listing via map-based advertising to help drive traffic to their listing.

Current ads systems like AdWords from Google associate an ad creative with sets of keywords. In embodiments consistent with the present invention, a location (e.g., an address or latitude, longitude coordinate) may be associated with each ad creative so that ad creatives and/or marker icons associated with ads can be properly plotted on the map. The ad server should send that information back to the requesting content (e.g., map) provider, as a map coordinate (e.g., latitude and longitude for each creative and/or marker icon). The advertiser may also be asked to provide a service area, such as a radius of service, for use in targeting and/or scoring its ad(s).

In at least some embodiments consistent with the present invention, an information entry front end user interface, such as the one in GoogleBase from Google can be used for uploading such location information. In at least some embodiments consistent with the present invention, larger advertisers (e.g., those more than a predetermined number of (e.g., 10) locations) can upload an “address feed”. Thus, for example, a large national advertiser uploading a list of locations to GoogleBase might be given the option of creating enhanced listings in the a search query keyword relevant advertising system (e.g., AdWords from Google).

§ 4.3.5.4 Determining Whether or Not to Show Ads

Referring back to FIG. 4, ad request information may include map-based location information, as well as other information that may be used to determine useful and relevant ads. Different embodiments consistent with the present invention may show ads with and/or on maps in different situations. For example, some embodiments might show ads anytime a map is rendered. Other embodiments might show ads when searching for an address, while other embodiments might show ads only when the user has initiated a commercial search (e.g. hotels in chicago). If ads are to always be shown, or shown in instances were a current end user interest cannot be easily inferred from a search query, some other information pertaining to a current user interest may be useful in determining relevant ads. For example, if third parties use an application program interface (API) to generate maps, there will likely be no search query to provide keywords used to determine relevant ads. Concepts, topics, clusters, and/or vertical categories to the third party document (e.g., Webpage (pertains) may be used to help find relevant ads. For example, techniques described in the '427 and '900 applications may be used, in concert with map-based location information, to determine relevant ads. Alternatively, or in addition, related information, such as searches, concepts, vertical categories, etc., could be provided for user selection. Techniques such as those described in the '870 application, the '101 application, the '267 provisional, and U.S. patent application Ser. No. 11/112,716 (incorporated herein by reference and referred to as “the '716 application), titled “CATEGORIZING OBJECTS, SUCH AS DOCUMENTS AND/OR CLUSTERS, WITH RESPECT TO A TAXONOMY AND DATA STRUCTURES DERIVED FROM SUCH CATEGORIZATION,” filed on Apr. 22, 2005 and listing David Gehrking, Ching Law and Andrew Maxwell as inventors, may be used for this purpose. Upon user selection, the selected information may be used, in concert with map-based location information, to determine relevant ads.

§ 4.3.5.5 Billing Options

Advertisers may be billed in various ways. For example, techniques described in U.S. patent application Ser. No. 11/228,583 (incorporated by reference and referred to as “the '583 application”), filed on Sep. 16, 2005, titled “FLEXIBLE ADVERTISING SYSTEM WHICH ALLOWS ADVERTISERS WITH DIFFERENT VALUE PROPOSITIONS TO EXPRESS SUCH VALUE PROPOSITIONS TO THE ADVERTISING SYSTEM”, and listing Sumit Agarwal, Gregory Joseph Badros, and John Fu as inventors may be used. In at least some embodiments consistent with the present invention, advertisers are charged on one or more of:
(a) a cost per selection (CPC) model when users select (e.g., click on) one or more of:
   a business name,
   a logo,
   a visible URL in the information bubble;
(b) a cost per impression (CPM) model based on one or more of
   per ad impression,
   per marker icon impression,
   per information bubble expansion/impression,
   per information bubble tab impression;
(c) a per-call basis (e.g., pay-to-call), particularly if the information bubble includes click-to-call functionality;
(d) coupon downloads may be supported and advertisers may be billed on a coupon download and/or coupon use basis;

### Note that information bubble impressions and information bubble tab impressions may be considered to be a type of user selection.

In some embodiments consistent with the present invention, the billing may be additive (e.g., advertiser is billed for each of marker icon impression, tab selection, and click-through to landing page). In other embodiments consistent with the present invention, the advertiser might be billed only for the highest value (e.g., in terms of what the advertiser bid) condition or user action that occurred. In such embodiments, if the advertiser offers $0.008 per marker icon impression, $0.10 per tab selection, and $0.50 per click-through, and all three occur, the advertiser is only billed for the $0.50 click-through (perhaps subject to a discount or some other adjustment).

§ 4.3.5.6 Ad Network Policy Checks

Ads can be checked for compliance with various policies in various ways. In at least some embodiments consistent with the present invention, ads or ad creative information that has already been approved or used in another ad serving system (e.g., AdWords from Google, or AdSense from Google) may be presumed to comply with policies of the ad server. In at least some embodiments consistent with the present invention, ads or listings derived from trusted directory listings may be presumed to comply with policies of the ad server. If ad creative information is not gathered from a trusted source, the advertiser and/or its ads may be subject to pre-serving or post-serving policy compliance checks.

In at least some embodiments consistent with the present invention, multiple advertisers can advertise on the same business listing. If an advertiser (e.g. Hilton) does not want others advertising on their location, they may be required to file trademark paperwork with the ad server. If this is done, the trademarked word in the business title (e.g., first line of text) may be captured, and an advertiser may be prevented from using that business name unless authorized by the trademark owner.

In at least some embodiments consistent with the present invention, logos, designs, animations, images, etc. may be reviewed manually for compliance with policies (e.g., no pornographic images).

§ 4.3.5.7 Sponsored Layers

There are different ways that advertiser information can be displayed in a manner consistent with the present invention. One way is through sponsored layers. With sponsored layers, advertisers can create a series of locations that would appear on the map when users clicked on the company, name (e.g. Starbuck's, Hertz, Holiday Inn). This is more useful for large, national advertisers. Thus, an advertiser can specify multiple locations, and ads and/or components thereof (e.g., marker icons) may be provided, at the specified locations, on a map to be rendered on a display.

§ 4.3.5.8 Resizing And/Or Re-centering Maps

In some embodiments consistent with the present invention, a size, scale, or center position of a map may be adjusted or re-determined using ad information. Various scenarios which illustrate resizing and/or re-centering are described. Suppose a screen includes a map and the user wants to see “restaurants”. In one scenario, suppose that most ads and listings for restaurants are clustered in one small portion of the map. In such a scenario, it might be desirable to rescale and/or re-center the map to zoom in on, and be centered on, that one small portion. This may be advantageous to the end user in that it separates the marker icons on the map, marker icon occlusion is avoided, and information is presented in a more intelligible form.

Under a second scenario, a present map might not contain any (or less than a predetermined number of) restaurant ads and listings, but a next level zoom-out of the map might contain restaurant ads/listings. It might be desirable to rescale the map to include such listings. Similarly, if an otherwise relevant ad having a business located outside of the map, has a service radius within the map, the map may be redrawn or otherwise re-rendered to include a marker icon corresponding to the ad.

Under a third scenario, a present map might contain too many (due to information overload, visual overload, marker occlusion, etc.) restaurant ads and listings. It might be desirable to rescale the map to zoom into less listings located close to the center of the present map, or centered on a cluster or clusters of listings.

### § 4.4 CONCLUSIONS

In view of the foregoing, the present invention allows more relevant ads to be served by using map-based location information. Embodiments consistent with the present invention may be used to create effective ways to bring end users and advertisers together in a graphical way that is beneficial to both parties, as well as an ad server and/or map content provider. Embodiments consistent with the present invention may provide a consistent ads solution, from the perspective of the end user and/or advertisers, for environments where the ad server and the map server are commonly controlled (e.g., Google Maps), as well as environments where the ad server and map content are not commonly controlled (e.g., Google Earth).

What is claimed is:

1. A computer-implemented method for determining a relevancy of an ad to a request, the method comprising:
a) accepting map-based location information associated with the request;
b) comparing the accepted map-based location information associated with the request with location targeting information associated with the ad to generate a comparison; and
c) determining the relevancy of the ad using at least the comparison.

2. The computer-implemented method of claim 1 wherein the request further includes search terms, and
wherein the act of determining the relevancy of the ad further uses a comparison of keyword targeting associated with the ad and the search terms.

3. The computer-implemented method of claim 1 wherein the request further includes document relevance information, and
wherein the act of determining the relevancy of the ad further uses a comparison of ad relevance information and the document relevance information.

4. The computer-implemented method of claim 1 wherein the map-based location information includes an area bound by the map.

5. The computer-implemented method of claim 1 wherein the map-based location information includes a map center location, and
wherein the act of determining the relevancy of the ad further uses a distance between a location associated with the ad and the map center location.

6. A computer-implemented method for determining a score of an ad, the method comprising:
a) accepting map-based location information associated with a request;
b) determining whether the ad has location price information corresponding to the map-based location information accepted; and
c) if it is determined that the ad has location price information corresponding to the map-based location information accepted, then determining the score using at least the location price information.

7. The computer-implemented method of claim 6 wherein the map-based location information includes an area bound by the map.

8. A computer-implemented method for determining a score of an ad, the method comprising:
a) accepting map-based location information associated with a request;
b) determining whether the ad has location performance information corresponding to the map-based location information accepted; and
c) if it is determined that the ad has location performance information corresponding to the map-based location information accepted, then determining the score using at least the location performance information.

9. The computer-implemented method of claim 8 wherein the map-based location information includes an area bound by the map.

10. A computer-implemented method comprising:
a) accepting an ad request including
(i) map-based location information, and
(ii) information indicating a user interest;
b) determining a set of one or more ads using the map-based location information and information indicating a user interest; and
c) rendering a map including, for each of the one or more ads, an icon at a location on the map corresponding to a location associated with the ad.

11. The computer-implemented method of claim 10 further comprising:
d) rendering, in a window including the map, each of the one or more ads.

12. The computer-implemented method of claim 11 further comprising:
e) accepting a user selection of one of the rendered one or more ads; and
f) rendering, in response to the accepted user selection, expanded information in association with, or in place of, the icon corresponding to the selected ad.

13. The computer-implemented method of claim 12 wherein the expanded information includes a multiple-tabbed information element.

14. The computer-implemented method of claim 12 wherein the expanded information includes a selectable click-to-call element.

15. The computer-implemented method of claim 10 wherein the map-based location information includes an area bound by the map.

16. The computer-implemented method of claim 10 wherein the map-based location information is associated with a map having a scale and center position, the method further comprising:
d) determining, using the determined a set of one or more ads, a new map having at least one of (A) a different scale and (B) a different center position, wherein the map rendered is the new map.

17. The computer-implemented method of claim 10 wherein at least some of ads of the set of one or more ads include an associated range of service.

18. The computer-implemented method of claim 17 wherein the act of determining a set of one or more ads using the map-based location information and information indicating a user interest further uses locations and ranges of service associated with ads.

19. A computer-implemented method comprising:
a) accepting an ad request including
(i) map-based location information, and
(ii) information indicating a user interest;
b) determining a set of one or more ads using the map-based location information and information indicating a user interest, wherein an advertiser associated with each of the one or more ads has agreed to make a payment conditioned upon at least one of (A) an impression, (B) a selection, and (C) a conversion;
c) determining a set of one or more listings using the map-based location information and information indicating a user interest; and
d) rendering a map including,
i) for each of the one or more ads, an icon at a location on the map corresponding to a location associated with the ad, and
ii) for each of the one or more listings, an icon at a location on the map corresponding to a location associated with the listing.

20. The computer-implemented method of claim 19 wherein the map-based location information includes an area bound by the map.

21. The computer-implemented method of claim 19 wherein the icons for each of the ads are icons of a first type, and wherein the icons for each of the listings are icons of a second type which differ from the icons of the first type.

22. The computer-implemented method of claim 21 wherein the icons of a first type include a logo or design associated with the advertiser, and wherein the icons of the second type include no logo or design associated with the advertiser.

23. The computer-implemented method of claim 21 wherein the icons of the first type are less conspicuous than the icons of the second type.

24. Apparatus comprising:
a) means for accepting an ad request including
(i) map-based location information, and
(ii) information indicating a user interest;
b) means for determining a set of one or more ads using the map-based location information and information indicating a user interest; and
c) means for rendering a map including, for each of the one or more ads, an icon at a location on the map corresponding to a location associated with the ad.
